(19) United States
(12) Patent Application Publication
(10) Pub. No.: US 2005/0059835 A1
(43) Pub. Date: Mar. 17, 2005

(54) Methods of refining silane compounds

(75) Inventors: Suzanne Wassmann-Wilken, Hanover (DE); Christian Werner, Hanover (DE); Joerg Wilken, Hanover (DE); Andreas Kanschik-Conradsen, Garbsen (DE)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 10/938,809

(22) Filed: Sep. 10, 2004

Related U.S. Application Data
(60) Provisional application No. 60/502,788, filed on Sep. 12, 2003.

(51) Int. Cl. C07F 7/20

(52) U.S. Cl. 556/437

(57) ABSTRACT

Provided are methods of producing refined silane compounds comprising providing a starting composition comprising a silane ester and an acidic halide and contacting the starting composition with an alkali metal salt selected from the group consisting of alkali metal salts derived from amides, imides, oxazolidinones, amines, sulfonamides, and combinations of two or more thereof.

### CROSS REFERENCE TO RELATED APPLICATIONS

This application claims priority benefit to U.S. Provisional Application No. 60/502,788 filed on Sep. 12, 2003, which is incorporated herein by reference.

### FIELD OF INVENTION

The present invention relates to methods of refining silane compounds. More specifically, the present invention relates to methods of producing silane compound compositions having relatively low concentration of acidic halide impurities and the silane compound compositions thereby produced.

### BACKGROUND

Silane compounds, including alkoxysilanes and alkenoxysilanes, are used advantageously in a wide variety of applications. For example, since alkoxysilanes and alkenoxysilanes tend to be non-corrosive and tend to facilitate relatively fast curing of sealants, they are well-suited for use in preparing silicone sealants which contact and bind delicate electronic components that are typically susceptible to corrosion.

However, applicants have recognized that many conventional syntheses of silane compounds, which utilize chlorinated starting materials and/or catalysts, tend to produce not only the desired silane, but also acidic halide by-products. Such acidic halide by-products tend to increase the corrosiveness of the resulting silane and tend to deactivate catalysts used in preparing silicone sealants, thus tending to negate the usefulness and benefits of incorporating the silane into sealants. While Applicants have recognized that a significant portion of the unwanted by-products can be removed via filtration, applicants have further noted that at least about 3-5% of the by-products remain in the filtered solution. The remaining acidic halide co-distills/sublimates during the distillation of the silane product, leading to product contamination.

A number of attempts to reduce the amount of acidic halide associated with silane ester products have been suggested. For example, in U.S. Pat. No. 5,084,588, Ocheltree describes introducing to certain metal salts to mixtures containing an alkoxysilane and an acidic halide to neutralize the acidic halide therein. U.S. Pat. No. 5,210,254 describes methods comprising the addition of excess metal alkoxide to an alkoxsilane product mixture to neutralize acidic halides associated therewith. U.S. Pat. No. 6,150,552 discloses the introduction of ammonia and alcoholates to reaction products comprising alkoxysilanes to neutralize acidic halides associated therewith. U.S. Pat. No. 6,242,628 discloses methods comprising adding alcoholates to an alkoxsilane product mixture to neutralize acidic halides associated therewith. All of the aforementioned patents are incorporated herein by reference.

Applicants have recognized that such known methods for reducing acidic halides tend to be disadvantageous for several reasons. For example, one disadvantage is that many of the above methods require expensive co-solvents for use in the processes. Another disadvantage is that many known methods require long contact times between the acidic halide and neutralizing agent (for example, the added metal salt, alcoholate, etc. must be maintained in contact with the acidic halide for 2 to 24 hours or longer) before relatively pure product can be obtained via such methods. Furthermore, prior to the addition of a neutralizing agent, many known methods require the measurement of the amount of acidic halide formed in the reaction, thus requiring extra time and equipment to obtain relatively pure silane esters. Also, some reactants used for removal of acidic halide in prior art, like metal alkoxides, tend to react with the silane ester.

Applicants have thus recognized the need for methods of purifying silanes that avoid the aforementioned disadvantages.

### DETAILED DESCRIPTION

The present invention overcomes these and other disadvantages of the prior art by providing methods of refining silane products so as to have relatively low amounts of acidic halide impurities, while avoiding the need for expensive co-solvents, long contact times, or extra measurement steps. In particular, applicants have discovered, unexpectedly, that silane products, such as alkoxysilanes and alkenoxysilanes having relatively low amounts of acidic halide, such as triethylamine-hydrochloride salt, can be obtained by contacting a starting composition comprising a silane and an acidic halide with alkali metal salts of amides, imides, oxazolidinones, amines, and sulfonamides which do not tend to react with the silicon of the silane esters. Although applicants do not wish to be bound to any theory of operation, it is believed that the alkali metal salt of the present invention, such as potassium phtalimide, tends to neutralize the acidic halides in the starting composition without liberating water, which could lead to the degradation of silane esters and other silanes. Therefore, contacting the starting composition with the alkali metal salt produces a refined composition containing silane and neutralized halide, such as potassium chloride. The silane of this refined composition can be separated readily from the neutralized halide via distillation to produce a purified composition of silane compounds. Thus, a purified composition of silane compounds can be obtained in a manner that is easier, more economical, and results in higher yield of silanes relative to other known purification methods. The present invention advantageously allows for the production of purified silane ester products having acidic halide concentration less than about 30 ppm, preferably less than about 10 ppm, and even more preferably less than about 5 ppm, based on the total weight of the silane.

Accordingly, one aspect of the present invention are methods of refining a silane product so as to have low amounts of acidic halide comprising the steps of (1) providing a starting composition comprising a silane compound and an acidic halide; and (2) contacting said starting composition with an alkali metal salt selected from the group consisting of alkali metal salts of amides, imides, oxazolidinones, amines, sulfonamides, and combinations of two or more thereof, to produce a refined composition of silane and neutralized halides. In certain embodiments, a purified silane ester product can be derived from the refined composition by (3) purifying the refined composition wherein the silane compound is separated from the neutralized halide and other unwanted impurities via distillation.

The providing step makes available a starting composition comprising a silane compound and an unwanted acidic halide.

As used herein, the term “silane” refers generally to a compound having the formula: 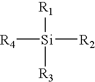
wherein R₁, R₂, R₃, and R₄ are independently a hydrolyzable radical selected from the group consisting of alkoxy, acyloxy, alkenoxy, amino, amido, amino, aminoxy, organo-functional alkoxy, and ketoximo having the formula —O—N═CR₅R₆, where R₅ is a vinyl, phenol, or saturated straight chain or branched alkyl radical of 1 to 7 carbon atoms, and R6 is methyl, ethyl, or propyl; or a hydrocarbon radical selected from the group consisting of substituted or unsubstituted C₁-C₁₀ straight-chain or branched alkyl, C₂-C₁₀ straight-chain or branched alkenyl, or a substituted or unsubstituted C₃-C₈ cyclic, aryl, aralkyl, arenyl, or aralkenyl group, or a heteroatom group derived therefrom; provided that at least one of R₁, R₂, R₃, and R₄ is a hydrolyzable radical as mentioned above.

Thus, a hydrolyzable group of the silane according to the claimed invention contains at least one carbon and can be alkoxy, including but are not limited to, methoxy, ethoxy, propoxy, isopropoxy, and methoxyethoxy; acyloxy, including but are not limited to, acetoxy and octanoyloxy; alkenoxy, including but are not limited to, propenoxy, isopropenoxy, and butenoxy; ketoximo having the formula —O—N═CR₅R₆, where R₅ is a vinyl, phenol, or saturated straight chain or branched alkyl radical of 1 to 7 carbon atoms such as methyl, ethyl, propyl, isopropyl, butyl, isobutyl and amyl, and R₆ is methyl, ethyl, or propyl; amido, including but are not limited to, N-methylacetamido, N-ethylpropionamido, N-ethylbenzamido, N-phenylacetamido, and N-propylpropionamido; amino, including but are not limited to, cyclohexylamino, sec-butylamino, diethylamino, and dimethylamino; aminoxy, including but not limited to aminoxydiethylhydroxylamine and dimethylhydroxylamine; and organo-functional alkoxy, including but are not limited to, amino organo alkoxy, epoxy organo alkoxy, mercapto organo alkoxy, isocyanto organo alkoxy, and methacyl organo alkoxy.

Silanes according to the claimed invention preferably have 3 or 4 hydrolyzable groups. However, in some applications 1 or 2 hydrolyzable groups may be desirable. Moreover, the silanes can be those in which the hydrolyzable groups are different in the same silane. For example, silanes can be those in which one hydrolyzable group is ketoximo and another hydrolyzable group is alkoxy. Such silanes are described by Klosowski et al in U.S. Pat. No. 4,657,967 and by Haugsby et al in U.S. Pat. No. 4,973,623, both of which are hereby incorporated by reference.

The hydrocarbon radical of the silane according to the claimed invention can be a substituted or unsubstituted C₁-C₁₀ straight-chain or branched alkyl or alkenyl or a substituted or unsubstituted C₃-C₈ cyclic, aryl, aralkyl, arenyl, or aralkenyl group, or a heteroatom group derived therefrom. Examples of such hydrocarbon radicals, include but are not limited to, methyl, ethyl, propyl, butyl, pentyl, phenyl, cyclohexyl, vinyl, allyl, hexenyl, and cyclohexenyl.

Examples of silanes according to the present invention therefore include, but are not limited to, methyltrimethoxysilane, vinyltrimethoxysilane, phenyltrimethoxysilane, trimethylmethoxysilane, vinyltriethoxysilane, tetraethyl orthosilicate, tetramethyl orthosilicate, ethyltrimethoxysilane, propyltrimethoxysilane, methyltriethoxysilane, phenyltriethoxysilane, butyltripropoxysilane, pentyltriisopropoxysilane, methyldimethoxyethoxysilane, methyldiethoxytnethoxysilane, methyltriacetoxysilane, ethyltriacetoxysilane, vinyltriacetoxysilane, methyltrioctanoyloxysilane, propyltriacetoxysilane, phenyltriacetoxysilane, ethyltrioctanoyloxysilane, methyltripropenoxysilane, ethyltripropenoxysilane, vinyltripropenoxysilane, tetrapropenoxysilane, dimethyl bis-(propenoxy) silane, methyl vinyl bis-(propenoxy)silane, trimethylisopropenoxysilane, methyl vinyl bis-(methyl isobutyl ketoximino)silane, methyl vinyl bis-(methyl amyl ketoximino)silane, methyl tris-(methyl isobutyl ketoximino)silane, vinyl tris-(methyl isobutyl ketoximino)silane, methyl tris-(methyl amyl ketoximino)silane, vinyl tris-(methyl amyl ketoximino)silane, tetrakis-(methyl isobutyl ketoximnino)silane, tetrakis-(methyl amyl ketoximino)silane, methoxy tris-(methyl isobutyl ketoximino)silane, ethyl tris-(methyl isobutyl ketoximino)silane, ethoxy tris-(methyl isobutyl ketoximino)silane, methoxy tris-(methyl amyl ketoximino)silane, ethyl tris-(methyl amyl ketoximino)silane, ethoxy tris-(methyl amyl ketoximino)silane, methyltri(N-methylacetamido)silane, vinyltri(N-methylacetamido)silane, gamma-aminopropyltriethoxysilane, gamma-aminopropyltrimethoxysilane, gamma-aminopropylmethyldiethoxysilane, N-(beta-aminoethyl)-gamma-aminopropyltrimethoxysilane, N-(beta-aminoethyl)-gamma-aminopropylmethyldiethoxysilane, N-(beta-aminoethyl)-gamma-aminopropylmethyldimethoxysilane, gamma-aminopropyltri(isopropenoxy)silane, N-(beta-aminoethyl)-gamma-aminopropyltri(isopropenoxy)silane. bis-(gamma-trimethoxysilylpropyl)amine, gamma-ureidopropyltrimethoxysilane, N-phenyl-gamma-aminopropyltrimethoxysilane, trimethoxysilypropyl diethylene triamine, gamma-glycidoxypropyltrimethoxy silane, gamma-glycidoxypropylmethyldiethoxysilane, gamma-methacryloxypropyltrimethoxysilane, gamma-isocyantopropyltriethoxydilane, gamma-mercaptopropyltrimethoxysilane, bis-(3-[triethoxysilyl]propyl)-tetrasulfane, methyltris-(methylisobutylketoximo)saline, methyl tris-(methyamylketoximino)silane, methyl vinyl bis-(N-methylacetamido)silane, methyl vinyl bis-(N-methylpropionamido)silane, methyl tris-(cyclohexylamino)silane, methyl tris-(sec-butylamino)silane, dimethyl bis-(diethylamino)silane, dimethyl bis-(dimethylamino)silane, and the like.

Silanes of the starting composition can be formed via any of a wide variety of methods known in the art. In certain preferred embodiments, the starting composition is formed by reacting silicon chloride with a compound comprising an enolizable carbonyl in the presence of a suitable metal salt catalyst and acid scavenger. In certain other preferred embodiments, the starting composition is formed by reacting silicon chloride with an alcohol in the presence of a suitable metal salt catalyst and acid scavenger. Other methods of making salines according to the present invention are described in U.S. Pat. Nos. 5,541,766, 5,084,588, and 5,264,603, each of which are incorporated inhere by reference.

Unfortunately, the above-mentioned reactions for producing silanes also produce acidic halide as an unwanted byproduct. For example, it is believed that the reaction of a chlorinated silicon compound with an enolizable carbonyl or alcohol in the presence of an acid scavenger such as triethylamine results in the dehalogentation and subsequent esterification of the silicon compound. The free chlorine radicals and hydrogen form a hydrogen halide compound that becomes bound to the triethylamine.

Most of this byproduct forms a precipitate which can be removed by filtration. However, depending on the particular filter used, approximately 3-5% of the overall acidic halide formed remains in solution. Thus, approximately 0.03-0.05 moles of acidic halide per mole of halide introduced as a silicon-halide reactant cannot be removed from the starting composition by filtration. Applicants have discovered that this remaining acidic halide can be neutralized by contacting the acidic halide with a neutralizing agent. Once the acidic halide has been neutralized, the silane product can be easily removed from neutralized halide via distillation.

The term “acidic halide” as used herein refers generally to an unbound hydrogen halide compound or a hydrogen halide compound which is bound to an amine. Examples of acidic halides include, but are not limited to, hydrogen fluoride, hydrogen chloride, triethylamine-hydrochloride, and the like.

The neutralizing agent according to the present invention is an alkali metal salt of an amide, imide, oxazolidinone, amine, and/or sulfonamide. A wide range of alkali metal salts are suitable for use according to the present invention. Examples of suitable alkali metal salts include salts of: amides, such as, 1,1,1,3,3,3-hexymethyldisilazane; imides, such as, potassium phthalimide, sodium phthalimide and the like; oxazolidinones, such as 4-benzyl-3-propionyl-2-oxazolidinone; amines, such as, diisopropylamine; sulfonamides, such as, benzene-1,2-disulfonicacidimide; mixtures of two or more thereof, and the like. Certain preferred alkali metal salts include imide salts such as potassium phthalimide, sodium phthalimide, and the like.

The selection of a neutralizing agent according to the present invention for a particular application is based upon two main criteria (1) the agent's capacity to neutralize acidic halides; and (2) the agent's non-reactivity with the silane product. Within the scope of alkali metal salts according to the present invention, a particular salt's ability to neutralize a particular halide can easily be determined by one skilled in the art without undue experimentation. Likewise, the salt's non-reactivity with the silane product (e.g. silane esters) can also be easily be determined by one skilled in the art without undue experimentation. Certain acidic halides and preferred alkali metal salts are shown in Table 1, however this Table is not intended to represent an exclusive list of the alkali metal salts and acidic halides within the scope of the present invention. Any of these alkali metal salts is capable of neutralizing all of the listed acidic halides.

TABLE 1

| Acidic Halide | Alkali Metal Salt |
|---|---|
| hydrogen fluoride | potassium-phthalimide |
| hydrogen chloride | sodium-phthalimide |
| triethylamine-hydrochloride | potassium-1,1,1,3,3,3-hexymethyldisilazane |
| hydrogen bromide | lithium-4-benzyl-3-propionyl- |
| | 2-oxazolidinone |
| triethylamine-hydrogen | lithium-diisopropylamine |
| bromide | potassium-benzene-1,2-disulfonicacidimide |

As will be recognized by those of skill in the art, the particular acidic halides present in the starting composition will depend, at least in part, on the materials used to derive the starting composition. For example, in certain preferred embodiments the starting composition is derived by reacting a silane chloride with an enolizable carbonyl compound in the presence of triethylamine wherein a silane ester is formed along with triethylamine-hydrochloride salt. This triethylamine-hydrochloride salt and any hydrochloride dissociated therefrom result in the undesirable acidic halide. In certain preferred embodiments, this acidic halide is contacted with the alkali metal salt potassium phthalimide. The potassium phthalimide neutralizes the hydrochloride via the formation of a phthalimide-sodium chloride complex or a phthalimide-triethylamine-sodium chloride complex.

With respect to the second criterion in the selection of a neutralizing agent, one skilled in the art would readily be able to determine which alkaline metal salts would be non-reactive with silane esters, etc. In general, the neutralizing agents or resulting neutralized complexes should be non-nuclephilic because the silane is able to undergo nucleophilic substitution. For example, potassium phthalimine has no adverse effect on vinyltriisopropenoxysilane or other alkyl- or alkenoxysilanes. Since the neutralizing agent does not have an adverse affect the silane product, it may be used in any amount equal to or greater than the amount necessary to neutralize all of the acidic halide. Thus, the exact halide content of the starting composition does not have to be determined in order to calculate the amount of neutralizing agent required to neutralize the byproduct.

Generally, alkali metal salts of the present invention will neutralize acidic halides on a 1:1 stoichiometric basis. Therefore, the molar amount of alkali metal salt required to neutralize the acidic halide byproduct is equivalent to the molar amount of acidic halide present in the composition. However, it is possible to use a stoichiometric excess of alkali metal salt because this salt does not react with the silane product. The optimum amount of alkali metal salt required will depend on the remaining acidic halide after filtration of the crude mixture. This can be determined experimentally by methods known in the art such as ion chromatography.

With respect to the contacting step, Applicants have discovered unexpectedly that the contact time required in the present invention is relatively short as compared to those taught in the art. As used herein, the term “contact time” refers generally to the time of contact between the alkali metal salt and provided mixture according to the present invention, as measured from the time of addition of alkali metal salt to the distillation of the mixture to provide purified silane ester. Preferably, the contact time according to the present invention is less than 1 hour, more preferably less than 30 minutes, even more preferably less than 15 minutes, and even more preferably less than 5 minutes.

As indicated above, certain embodiments of the claimed invention may also comprise the step of distilling the intermediate composition provided via the contacting step to provide a purified silane ester having associated therewith less acidic halide than in the provided mixture. Any of a wide range of distillation apparatus and methods can be adapted for use in the present distillation step. Those of skill in the art will be readily able to adapt known distillation methods for use in the present methods without undue experimentation.

According to another aspect of the present invention, the acidic halide concentration of a silane product, such as enoxysilane, is reduced from about 25,000 ppm (i.e. about 2.5%) to about 5 ppm (i.e. by about 0.0005%), and preferably to about 0.5 ppm (i.e. by about 0.00005%). Thus, silane compounds are provided having an acidic halide concentration of less than about 30 ppm, preferably less than about 5 ppm, and even more preferably less than about 0.5 ppm, based on the total weight of the silane.

The following examples illustrate certain aspects of the present invention. However, the examples are set forth for illustrations only and are not to be construed as limitations on the claimed invention.

### EXAMPLES

### Example 1

This example illustrates the production of vinyltriisopropenoxysilane according to the present invention.

A three-necked 1000 mL flask, equipped with a stirrer, thermometer, metal condenser, gas bubbler and nitrogen line is charged with 225.6 grams (3.88 moles, 6.5 eq.) of acetone under a slight nitrogen stream. Under nitrogen and stirring, 242.8 grams (2.4 moles, 4 eq.) of triethylamine and 1.2 grams (12 mmols, 2%) copper chloride (CuCl) are added. Upon observation, the mixture turns blue and then green. The mixture is heated to 40° C., then heating is removed. Via addition funnel, 96.8 grams (0.6 mols) of vinyltrichlorosilane are added over 15-25 minutes under nitrogen and with vigorous stirring and no additional heating so that a temperature of 50-60° C. is maintained. Upon observation, the mixture turns yellow and then brown. A triethylamine-HCl precipitate forms. The mixture is heated under nitrogen and with stirring to a reflux (59° C. pot temperature) for 18 hours. The precipitate is filtered under nitrogen into a 1000 mL 3-necked flask, the cake is washed with an overall of 150-200 mL acetone until the filtrate is nearly colourless. Potassium phthalimide, 16.7 grams (0.09 mols) and 70 g of Parrafine are added to the filtrate. The flask is fit with a thermometer, 30 cm-packed column, vacuum-column-head and vacuum line. A 300 mbar vacuum is achieved and the mixture is heated to a pot-temperature of 35° C., gradually rising to 60° C., retaining a columnhead temperature of 32-34° C. (at which temperature acetone and triethylamine are distilled off). The vacuum is brought to 11-17 mbar and a small fraction of acetone and triethylamine is taken. The pot temperature is then raised to 70° C., gradually rising to 130° C., retaining a head temperature of 60-70° C. (depending on the vacuum). Vinyltriisopropenoxysilane, 97.8 grams (0.43 mols, 72% yield), is collected and stored under nitrogen. In larger batches, a 77% yield has been obtained. Examples 2-6 are prophetic examples illustrating embodiments of the invention.

### Example 2

A mixture of 65 moles of acetone, 40 moles of triethylamine, and 0.12 moles of copper chloride is introduced into a reaction vessel equipped with a nitrogen gas source. Nitrogen is introduced into the vessel to create a nitrogen blanket at approximately ambient pressure. The mixture is stirred and maintained at approximately 60° C. Into this mixture is added 6 moles of vinyltrichlorosilane. As the reaction progresses and vinyltriisopropenoxysilane produced, the acidic halide triethylamine-HCl precipitate forms. After the reaction is substantially complete, the product is filtered to remove most of the solid triethylamine-HCl from the mixture.

The remaining filtrate is transferred into another vessel and heated to approximately 60-70° C. Sampling of the filtrate indicates that approximately 0.9 moles of triethylamine-HCl are present. Approximately 0.9 moles of sodium phthalimide is added to the filtrate. After 5 minutes, the solution is distilled. The silane product after distillation contains less than 30 ppm of acidic halide.

### Example 3

A method similar to the one described in Example 2 is performed, except that acidic halide is neutralized by potassium-1,1,1,3,3,3-hexymethyldisilazane.

### Example 4

A method similar to the one described in Example 2 is performed, except that acidic halide is neutralized by lithium-4-benzyl-3-propionyl-2-oxazolidinone.

### Example 5

A method similar to the one described in Example 2 is performed, except that acidic halide is neutralized by lithium-diisopropylamine.

### Example 6

A method similar to the one described in Example 2 is performed, except that acidic halide is neutralized by potassium-benzene-1,2-disulfonicacidimide.

1. A method of refining a silane ester product comprising the steps of:
(a) providing a starting composition comprising a silane compound and an acidic halide; and
(b) contacting said starting composition with an alkali metal salt of a nitrogen containing compound selected from the group consisting of amides, imides, oxazolidinones, amines, sulfonamides, and combinations of two or more thereof to produce a refined silane ester product having an acidic halide concentration lower than that of said starting composition.

2. The method of claim 1, further comprising the step of:
(c) purifying said silane ester wherein said silane is separated from said neutralized halide.

3. The method of claim 2, wherein said purifying step comprises distillation.

4. The method of claim 1 wherein said silane compound has the formula: 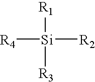
wherein R₁, R₂, R₃, and R₄ are independently
(a) a hydrolyzable radical selected from the group consisting of alkoxy, acyloxy, alkenoxy, amino, amido, amino, aminoxy, organo-functional alkoxy, and ketoximo having the formula —O—N═CR₅R₆, where R₅ is vinyl, phenol, or saturated straight chain or branched alkyl radical of 1 to 7 carbon atoms, and R₆ is methyl, ethyl, or propyl; or
(b) a hydrocarbon radical selected from the group consisting of substituted or unsubstituted C₁-C₁₀ straight-chain or branched alkyl, C₂-C₁₀ straight-chain or branched alkenyl, or a substituted or unsubstituted C₃-C₈ cyclic, aryl, arylalkyl, arenyl, or arylalkenyl group, or a heteroatom group derived therefrom;
provided that at least one of R₁, R₂, R₃, and R₄ is said hydrolyzable radical.

5. The method of claim 1 wherein said starting composition is derived by reacting silane chloride with an enolizable carbonyl compound in the presence of triethylamine.

6. The method of claim 5 wherein said silane chloride is selected from the group consisting of tetrachlorosilane, vinyltrichlorosilane, methyltrichlorosilane, methylvinyldichlorosilane, dimethyldichlorosilane, chloropropyltrichlorosilane, trimethylchlorosilane, phenyltrichlorosilane, and combinations of two or more thereof; and wherein said enolizable carbonyl compound is selected from the group consisting of acetone, methylethylketone, diethylketone, methylpropylketone, methylbutylketone, methylnonylketone.

7. The method of claim 6 wherein said silane chloride is vinyltrichlorosilane and said enolizable carbonyl compound is acetone.

8. The method of claim 1 wherein said acidic halide is triethylamine-hydrochloride.

9. The method of claim 1 wherein said nitrogen-containing compound is selected from the group consisting of 1,1,1,3,3,3-hexymethyldisilazane, phthalimide, 4-benzyl-3-propionyl-2-oxazolidinone, diisopropylamine, benzene-1,2-disulfonicacidimide, and mixtures of two or more thereof.

10. The method of claim 1 wherein said alkali metal salt is an alkali metal salt of a tertiary amine.

11. The method of claim 10 wherein said alkali metal salt is potassium phtalimide.

12. The method of claim 1 wherein said silane compound of said starting composition is produced from a silane chloride reagent and wherein from about 15 to about 40 mole percent of said alkali metal salt based on the weight of said silane chloride is contacted with said starting composition.

13. The method of claim 12 wherein said silane compound of said starting composition is produced from a silane chloride reagent and wherein from about 15 to about 30 mole percent of said alkali metal salt based on the weight of said silane chloride is contacted with said starting composition.

14. The method of claim 13 wherein said silane compound of said starting composition is produced from a silane chloride reagent and wherein from about 15 to about 20 mole percent of said alkali metal salt based on the weight of said silane chloride is contacted with said starting composition.

15. The method of claim 1 wherein the duration of said contacting step is less than 15 minutes.

16. The method of claim 1 wherein the duration of said contacting step is less than 5 minutes.
